(19) United States
(12) Patent Application Publication
(10) Pub. No.: US 2007/0106720 A1
(43) Pub. Date: May 10, 2007

(54) Reconfigurable signal processor architecture using multiple complex multiply-accumulate units

(75) Inventors: Eran Pisek, Plano, TX (US); Yan Wang, Plano, TX (US); Jasmin Oz, Plano, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 11/584,175

(22) Filed: Oct. 20, 2006

Related U.S. Application Data
(60) Provisional application No. 60/736,087, filed on Nov. 10, 2005.
(60) Provisional application No. 60/800,349, filed on May 15, 2006.

(51) Int. Cl. G06F 7/38

(52) U.S. Cl. 708/523

(57) ABSTRACT

A reconfigurable digital signal processor (DSP) comprises: a reconfigurable data path comprising a plurality of reconfigurable multiply-accumulate (MAC) units; and a programmable finite state machine for controlling the plurality of reconfigurable MAC units. The programmable finite state machine executes a first plurality of context-related instructions that cause selected ones of the plurality of reconfigurable MAC units to perform at least one of a defined set of functions consisting essentially of: i) Fourier transform functions; and ii) filter functions. The Fourier transform functions comprise a Fast Fourier Transform (FFT) function and an Inverse Fast Fourier Transform (FFT) function and the filter functions comprise a finite impulse response (FIR) filter function and an infinite impulse response (IIR) filter function.

### CROSS-REFERENCE TO RELATED APPLICATIONS AND CLAIM OF PRIORITY

This application is related to U.S. Provisional Patent No. 60/736,087, filed Nov. 10, 2005, entitled “MAC CRISP” and to U.S. Provisional Patent No. 60/800,349, filed May 15, 2006, entitled “MAC CRISP”. Provisional Patent Nos. 60/736,087 and 60/800,349 are assigned to the assignee of this application and are incorporated by reference as if fully set forth herein. This application claims priority under 35 U.S.C. §119(e) to Provisional Patent Nos. 60/736,087 and 60/800,349.

This application is related to U.S. patent application Ser. No. 11/123,313, filed May 6, 2005, entitled “Context-Based Operation Reconfigurable Instruction Set Processor And Method Of Operation.” application Ser. No. 11/123,313 is assigned to the assignee of this application and is incorporated by reference into this application as if fully set forth herein.

### TECHNICAL FIELD OF THE INVENTION

The present application relates generally to a reconfigurable digital signal processor (DSP) and, more specifically, to DSP that implements a multiple complex multiply-accumulate (MAC) unit architecture.

### BACKGROUND OF THE INVENTION

The currently evolving wireless communication standards, such as IEEE-802.16e (i.e., WiBro) and IEEE-802.11n, require ever higher bit rates. The target bit rate requirements have already passed the 10 Mbps mark and are quickly heading towards the 100 Mbps range. The hardware and software platforms used in current wireless network infrastructure and mobile devices must be adapted to the new demanding bit rates.

Digital signal processors designed for conventional wireless standards cannot support the higher bit rates of the evolving standards. To meet the higher bit rates, the single complex multiply-accumulate (MAC) unit in a conventional digital signal processor (DSP) design has been replaced by multiple complex multiply-accumulate (MAC) units that may operate in parallel. U.S. Pat. No. 6,298,366 to Gatherer et al. discloses a reconfigurable MAC unit that is adapted for multiple multiply-accumulate operations. U.S. Pat. No. 6,298,366 is incorporated into the present disclosure as if fully set forth herein.

Unfortunately, while incorporating multiple MAC units in a DSP may enable the DSP to achieve higher bit rates, the power consumption of the DSP rises significantly. As a result, multiple MAC unit designs have been limited to use in network base stations and other infrastructure where low power consumption is not a paramount concern. However, because of their poor power efficiency, multiple MAC units have not been used in handset devices or other mobile applications that rely on battery power.

Therefore, there is a need in the art for an improved digital signal processor that can meet the higher bit rates of the evolving wireless standards, such as the IEEE-802.16e and IEEE-802.11n standards. In particular, there is a need for a reconfigurable DSP that incorporates multiple complex multiply-accumulate (MAC) units that have reduced power consumption and are suitable to mobile applications.

### SUMMARY OF THE INVENTION

In one embodiment of the disclosure, a reconfigurable digital signal processor (DSP) is provided. The reconfigurable DSP comprises: a reconfigurable data path comprising a plurality of reconfigurable multiply-accumulate (MAC) units; and a programmable finite state machine for controlling the plurality of reconfigurable MAC units. The programmable finite state machine executes a first plurality of context-related instructions that cause selected ones of the plurality of reconfigurable MAC units to perform at least one of a defined set of functions consisting essentially of: i) Fourier transform functions; and ii) filter functions. In an advantageous embodiment, the Fourier transform functions comprise a Fast Fourier Transform (FFT) function and an Inverse Fast Fourier Transform (FFT) function and the filter functions comprise at least a finite impulse response (FIR) filter function and an infinite impulse response (IIR) filter function.

In another embodiment, a software-defined radio (SDR) system that operates under a plurality of wireless communication standards is provided. The SDR system comprises a reconfigurable signal processor comprising: a reconfigurable data path comprising a plurality of reconfigurable multiply-accumulate (MAC) units; and a programmable finite state machine for controlling the plurality of reconfigurable MAC units. The programmable finite state machine executes a first plurality of context-related instructions that cause selected ones of the plurality of reconfigurable MAC units to perform at least one of a defined set of functions consisting essentially of: i) Fourier transform functions; and ii) filter functions.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a high-level block diagram of a CRISP device that implements multiple complex multiply-accumulate (MAC) units according to the principles of the present disclosure;

FIG. 2 is a high-level block diagram of a reconfigurable processing system according to one embodiment of the present disclosure;

FIG. 3 is a high-level block diagram of a multi-standard software-defined radio (SDR) system that implements multiple complex multiply-accumulate (MAC) units according to one embodiment of the present disclosure;

FIG. 4 illustrates a transform CRISP in greater detail according to an exemplary embodiment of the present invention; and

FIGS. 5A-5C illustrate a VLIW instruction set for a multiple MAC unit CRISP.

### DETAILED DESCRIPTION OF THE INVENTION

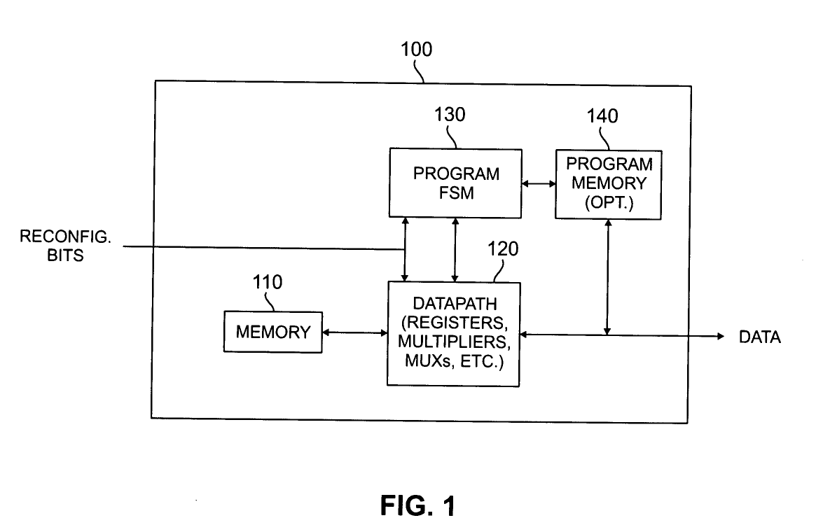

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged processing system.

In the descriptions that follow, the multiple complex MAC unit architecture disclosed herein is implemented in context-based operation reconfigurable instruction processor (CRISP) that performs Fourier transform operations and filtering operations in support of high data rate standards. CRISP devices are described in detail in U.S. patent application Ser. No. 11/123,313, which was incorporated by reference above.

FIG. 1 is a high-level block diagram of context-based operation reconfigurable instruction set processor (CRISP) 100, which implements multiple complex multiply-accumulate (MAC) units according to the principles of the present disclosure. CRISP 100 comprises memory 110, programmable data path circuitry 120, programmable finite state machine 130, and optional program memory 140. A context is a group of instructions of a data processor that are related to a particular function or application, such as Fourier Transform instructions, finite impulse response (FIR) filter instructions, infinite impulse response (IIR) filter instructions, and the like. As described in U.S. patent application Ser. No. 11/123,313, CRISP 100 does not implement all possible DSP instructions, but rather implements only a subset of context-related instructions in an optimum manner.

Context-based operation reconfigurable instruction set processor (CRISP) 100 defines the generic hardware block that usually consists of higher level hardware processor blocks. The principle advantage to CRISP 100 is that CRISP 100 breaks down the required application into two main domains, a control domain and a data path domain, and optimizes each domain separately. By performing a limited group of context related instructions (e.g., Fast Fourier transform (FFT) instructions, inverse Fast Fourier transform (IFFT) instructions, FIR instructions and IIR instructions) in multiple complex multiply-accumulate (MAC) units in CRISP 100, the disclosed DSP reduces the power consumption problems of conventional multiple MAC unit designs.

The control domain is implemented by programmable finite state machine (FSM) 130, which may comprise a conventional design. Programmable FSM 130 is configured by reconfiguration bits received from an external controller (not shown). Programmable FSM 130 executes a program stored in associated optional program memory 140. The program may be stored in program memory 140 via the DATA line from an external controller (not shown). Memory 110 is used to store application data used by data path circuitry 120.

Programmable data path circuitry 120 is divided into sets of building blocks that perform particular functions (e.g., registers, multiplexers, multipliers, and the like). Each of the building blocks is both reconfigurable and programmable to allow maximum flexibility. The division of programmable data path circuitry 120 into functional blocks depends on the level of reconfigurability and programmability required for a particular application.

Since different contexts are implemented by separate CRISP devices that work independently of other CRISP devices, implementing multiple MAC units using one or more CRISP devices provides an efficient power management scheme that is able to shut down a CRISP when the CRISP is not required. This assures that only the CRISPs that are needed at a given time are active, while other idle CRISPs do not consume significant power. By way of example, when the multiple MAC unit CRISPs are performing FFT/IFFT functions or filtering functions, a turbo coder CRISP may be turned off. In a conventional DSP, the turbo coder remains active and consumes power while the multiple MAC circuits are processing received data.

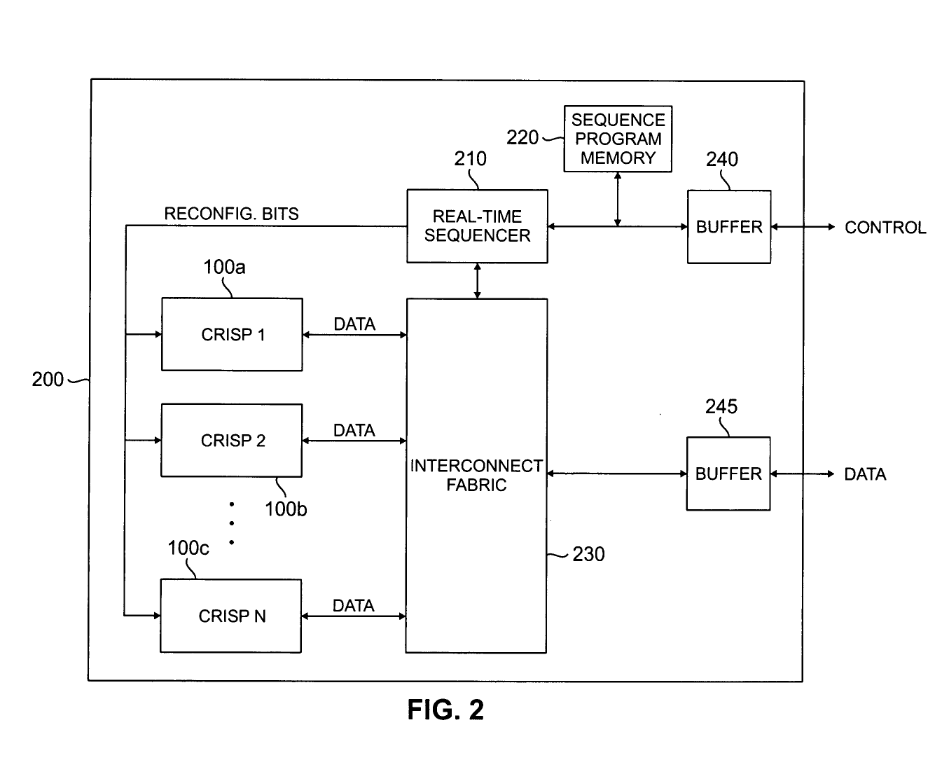

FIG. 2 is a high-level block diagram of reconfigurable processing system 200 according to one embodiment of the present disclosure. Reconfigurable processing system 200 comprises N context-based operation reconfigurable instruction set processors (CRISPs), including exemplary CRISPs 100a, 100b, and 100c, which are arbitrarily labeled CRISP 1, CRISP 2 and CRISP N. Reconfigurable processing system 200 further comprises real-time sequencer 210, sequence program memory 220, programmable interconnect fabric 230, and buffers 240 and 245.

Reconfiguration bits may be loaded into CRISPs 100a, 100b, and 100c from the CONTROL line via real-time sequencer 210 and buffer 240. A control program may also be loaded into sequence program memory 220 from the CONTROL line via buffer 240. Real-time sequencer 210 sequences the contexts to be executed by each one of CRISPs 100a-c by retrieving program instructions from program memory 220 and sending reconfiguration bits to CRISPs 100a-c. In an exemplary embodiment, real-time sequencer 210 may comprise a stack processor, which is suitable to operate as a real-time scheduler due to its low latency and simplicity.

Reconfigurable interconnect fabric 230 provides connectivity between each one of CRISPs 100a-c and an external data bus via bi-directional buffer 245. In an exemplary embodiment of the present disclosure, each one of CRISPs 100a-c may act as a master of reconfigurable interconnect fabric 230 and may initiate address access. The bus arbiter for reconfigurable interconnect fabric 230 may be internal to real-time sequencer 210.

In an exemplary embodiment, reconfigurable processing system 200 may be, for example, a cell phone or a similar wireless device, or a data processor for use in a laptop computer. In a wireless device embodiment based on a software-defined radio (SDR) architecture, each one of CRISPs 100a-c is responsible for executing a subset of context-related instructions that are associated with a particular reconfigurable function. For example, one or more of CRISPs 100a, 100b and 100c may be configured to operate as multiple MAC units that perform FFT/IFFT functions or FIR/IIR filter functions.

Since CRISP devices are largely independent and may be run simultaneously, a multiple MAC unit architecture implemented using one or more CRISP devices has the performance advantage of parallelism without incurring the full power penalty associated with running parallel operations. The loose coupling and independence of CRISP devices allows them to be configured for different systems and functions that may be shut down separately.

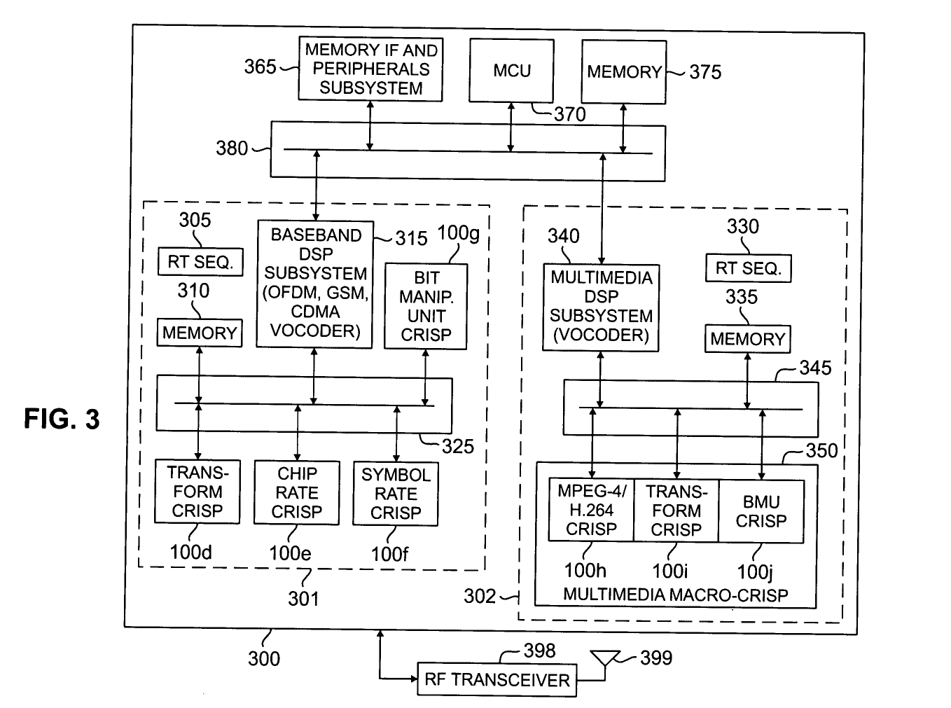

FIG. 3 is a high-level block diagram of multi-standard software-defined radio (SDR) system 300, which implements multiple complex multiply-accumulate (MAC) units according to the principles of the present disclosure. SDR system 300 may comprise a wireless terminal (or mobile station, subscriber station, etc.) that accesses a wireless network, such as, for example, a GSM or CDMA cellular telephone, a PDA with WCDMA, IEEE-802.11x, OFDM/OFDMA capabilities, or the like.

Multi-standard SDR system 300 comprises baseband subsystem 301, applications subsystem 302, memory interface (IF) and peripherals subsystem 365, main control unit (MCU) 370, memory 375, and interconnect 380. MCU 370 may comprise, for example, a conventional microcontroller or a microprocessor (e.g., x86, ARM, RISC, DSP, etc.). Memory IF and peripherals subsystem 365 may connect SDR system 300 to an external memory (not shown) and to external peripherals (not shown). Memory 375 stores data from other components in SDR system 300 and from external devices (not shown). For example, memory 375 may store a stream of incoming data samples associated with a down-converted signal generated by radio frequency (RF) transceiver 398 and antenna 399 associated with SDR system 300. Interconnect 380 acts as a system bus that provides data transfer between subsystems 301 and 302, memory IF and peripherals subsystem 365, MCU 370, and memory 375.

Baseband subsystem 301 comprises real-time (RT) sequencer 305, memory 310, baseband DSP subsystem 315, interconnect 325, and a plurality of special purpose context-based operation instruction set processors (CRISPs), including transform CRISP 100d, chip rate CRISP 100e, symbol rate CRISP 100f, and bit manipulation unit (BMU) CRISP 100g. By way of example, transform CRISP 100d may comprise a multiple complex MAC unit that implements FFT/IFFT functions, FIR filter functions and/or IIR filter functions. Likewise, chip rate CRISP 100e may implement a correlation function for a CDMA signal and symbol rate CRISP 100f may implement a turbo decoder function or a Viterbi decoder function.

In such an exemplary embodiment, transform CRISP 100d may receive samples of an intermediate frequency (IF) signal stored in memory 375, perform an FFT function that generates a sequence of chip samples at a baseband rate, and then perform a filter function (e.g., root raised cosine, spectrum shaping) on the sequence of chip samples. Next, chip rate CRISP 100e receives the filtered chip samples from transform CRISP 100d and performs a correlation function that generates a sequence of data symbols. Next, symbol rate CRISP 100f receives the symbol data from chip rate CRISP 100e and performs turbo decoding or Viterbi decoding to recover the baseband user data. The baseband user data may then be used by applications subsystem 302.

In an exemplary embodiment of the present disclosure, symbol rate CRISP 100f may comprise two or more CRISPs that operate in parallel. Also, by way of example, BMU CRISP 100g may implement such functions as variable length coding, cyclic redundancy check (CRC), convolutional encoding, and the like. Interconnect 325 acts as a system bus that provides data transfer between RT sequencer 305, memory 310, baseband DSP subsystem 315 and CRISPs 100d-100g.

Applications subsystem 302 comprises real-time (RT) sequencer 330, memory 335, multimedia DSP subsystem 340, interconnect 345, and multimedia macro-CRISP 350. Multimedia macro-CRISP 350 comprises a plurality of special purpose context-based operation instruction set processors, including MPEG-4/H.264 CRISP 550h, transform CRISP 550i, and BMU CRISP 100j. In an exemplary embodiment of the disclosure, MPEG-4/H.264 CRISP 550h performs motion estimation functions and transform CRISP 100h performs a discrete cosine transform (DCT) function. Interconnect 380 provides data transfer between RT sequencer 330, memory 335, multimedia DSP subsystem 340, and multimedia macro-CRISP 350.

In the embodiment in FIG. 3, the use of CRISP devices enables applications subsystem 302 of multi-standard SDR system 300 to be reconfigured to support multiple video standards with multiple profiles and sizes. Additionally, the use of CRISP devices enables baseband subsystem 301 of multi-standard SDR system 300 to be reconfigured to support multiple air interface standards. Thus, SDR system 300 is able to operate in different types of wireless networks (e.g., CDMA, GSM, 802.11x, etc.) and can execute different types of video and audio formats. However, the use of CRISPS according to the principles of the present disclosure enables SDR system 300 to perform these functions with much lower power consumption than conventional wireless devices having comparable capabilities.

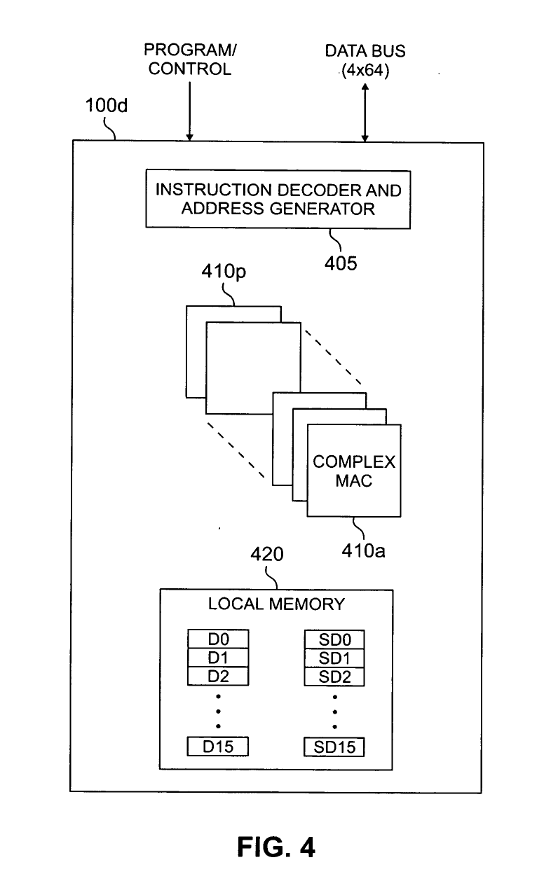

FIG. 4 illustrates transform CRISP 100d in greater detail according to an exemplary embodiment of the present invention. Context-based operation reconfigurable instruction set processor (CRISP) 100d comprise instruction decoder and address generator block 405, sixteen (16) reconfigurable complex multiply-accumulate (MAC) units 410a-410p, and local memory 420. As in FIG. 1, CRISP 100d splits the complex MAC application into two main domains: a control domain that is implemented by instruction decoder and address generator block 405 and a datapath domain that is implemented by reconfigurable complex MAC units 410a-410p. Thus, instruction decoder and address generator block 405 is comparable to programmable data path circuitry 120 and reconfigurable complex MAC units 410a-410p are comparable to programmable finite state machine 130.

The localization of memory 420 is important to reduce the capacitance and power consumption of the data buses. Local memory 420 is comparable to memory 110 in FIG. 1. Local memory 420 comprises a first group of sixteen (16) registers D0-D15 and a second group of sixteen (16) registers SD0-SD15 that hold data values that may be accessed by the sixteen MAC units 410a-410p. It will be understood that the selection of 16 MAC units is by way of example only and should not be construed to limit the scope of the disclosure. Those skilled in the art will understand that, in alternate embodiments, more than 16 or less than 16 MAC units may be implemented.

Instruction decoder and address generator block 405 received program and control bits from an external controller, such as MCU 370 and used the program and control bits to reconfigure one or more of MAC units 410a-410p according to the desired function. MAC CRISP 100d uses variable-length Very Long Instruction Word (VLIW)-based instructions with nested loop control.

In an advantageous embodiment, instruction decoder and address generator block 405 may implement a pipeline controller as disclosed in U.S. patent application Ser. No. 11/150,427, filed Jun. 10, 2005 and entitled “Pipeline Controller For Context-Based Operation Reconfigurable Instruction Set Processor”, which is assigned to the assignee of the present application and is incorporated by reference as if fully set forth in the present application. The instruction pipeline in application Ser. No. 11/150,427 repetitively executes a loop of instructions by fetching and decoding a first loop instruction during a first loop iteration, storing first decoded instruction information for the first instruction during the first loop iteration, and using the stored first decoded instruction information during at least a second loop iteration without further fetching and decoding of the first instruction.

Additionally, in an advantageous embodiment, instruction decoder and address generator block 405 may implement nested loop control as disclosed in U.S. patent application Ser. No. 11/317,361, filed Dec. 23, 2005 and entitled “System And Method For Executing Loops In A Processor”, which is assigned to the assignee of the present application and is incorporated by reference as if fully set forth in the present application. The loop control system in application Ser. No. 11/317,361 comprises a loop flag in an instruction word, a loop counter associated with the loop flag for storing and computing a number of times a program loop is to be executed, a start address register associated with the loop flag for storing a program loop starting address, and an end address register associated with the loop flag for storing a program loop ending address.

Moreover, instruction decoder and address generator block 405 may implement an address generator as disclosed in U.S. patent application Ser. No. 11/521,661, filed Sep. 15, 2006 and entitled “Method And System For Generating Addresses For A Processor”, which is assigned to the assignee of the present application and is incorporated by reference as if fully set forth in the present application. The address generator disclosed in application Ser. No. 11/521,661 generates addresses for an application that may be executed by a processor, such as CRISP 100d. The application comprises a plurality of instructions, such as the variable-length VLIW in CRISP 100d, and each instruction comprises at least one line. The address generator stores a plurality of predetermined addresses and, for each line of each instruction, generates at least one address for the processor based on the predetermined addresses.

MAC CRISP 100d differs from conventional digital signal processors by targeting essentially Fourier Transform (FT) functions, FIR/IIR filter functions, and a small number of related functions. While this limits the capabilities of reconfigurable MAC units 410a-410p, it also saves power by allowing MAC units 410a-410p to be disabled when the targeted functions are not being executed (i.e., transform CRISP 100d is not in use). Additionally, transform CRISP 100d is scalable, so that MAC units 410a-410p may be selectively enabled according to the incoming data rate.

For relatively low data rate standards (e.g., CDMA2000), only a small number (e.g., 4) of MAC units 410a-410p may be enabled while the remaining ones of MAC units 410a-410p are disabled, thereby saving power. For relatively high data rate standards (e.g., IEEE-802.16e or IEEE-802.11n), all of MAC units 410a-410p may be enabled. As a result, the power efficiency of the reconfigurable and scalable MAC units make CRISP 100d suitable for use in wireless handsets (e.g., cell phones) and other mobile devices.

The essential filter functions supported by reconfigurable complex MAC units 410a-410p may be generally expressed by Equation 1 below:

$$y [ n ] = {\sum }_{i = 0}^{N - 1} {b}_{i} x ( n - i ) + {\sum }_{i = 0}^{N - 1} {a}_{i} y ( n - i ) \qquad [ Eqn . 1 ]$$

Digital filters may be classified into two broad categories: finite impulse response (FIR) filters and infinite impulse response (IIR) filters. If a system does not contain feedback elements, the filter is an FIR filter and all aᵢ terms in Equation 1 are equal to 0. However, if at least some of the aᵢ terms and at least some of the bᵢ terms in Equation 1 are non-zero, then the filter is an IIR filter.

The essential Fourier Transform (i.e., FFT and IFFT) functions supported by reconfigurable complex MAC units 410a-410p may be generally expressed by Equations 2 and 3 below:

$$\begin{matrix}X [ k ] = {\sum }_{n = 0}^{N - 1} x ( n ) {ⅇ}^{- j 2 π ki / N} ( FFT ) & [ Eqn . 2 ] \\ x ( n ) = \frac{1}{N} {\sum }_{n = 0}^{N - 1} X ( k ) {ⅇ}^{j 2 π ki / N} ( IFFT ) & [ Eqn . 3 ]\end{matrix}$$

As can be seen in Equations 1-3, the main mathematical operations are to multiply each input sample by a constant and then accumulate each of the products over the N cycles. MAC units 410a-410p are optimized for such mathematical operations.

Thus, MAC units 410a-410p enable CRISP 100d to support a number of algorithms related to Fourier Transform and filter functions including: 1) complex FFT from 64 to 8192 points using radix 2, radix 4 or mixed radix calculations; 2) adaptive digital predistortion; 3) complex/real FIR/IIR filters; 4) adaptive filtering (e.g., LMS); 5) Root Raised Cosine (RRC) and matched filters; 6) adaptive equalization (e.g., DFE); 7) channel estimation; 8) searcher; 9) synchronization; 10) frequency and phase corrections; 11) shaping filters (e.g., spectrum shaping); 12) digital up/down conversions (e.g., fractional and integer); 13) soft clipping (CFR); and 14) IQ compensation.

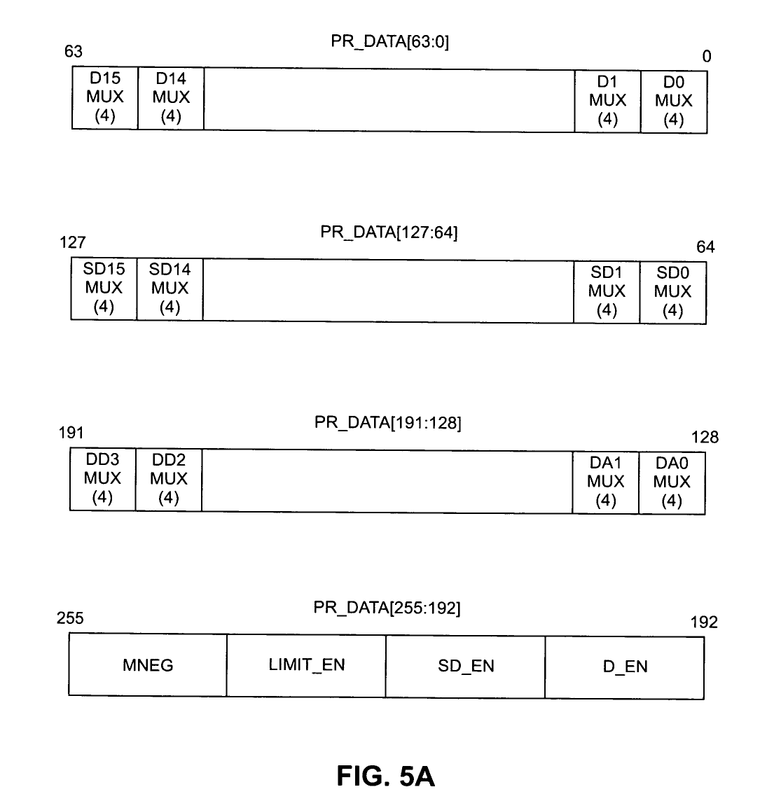

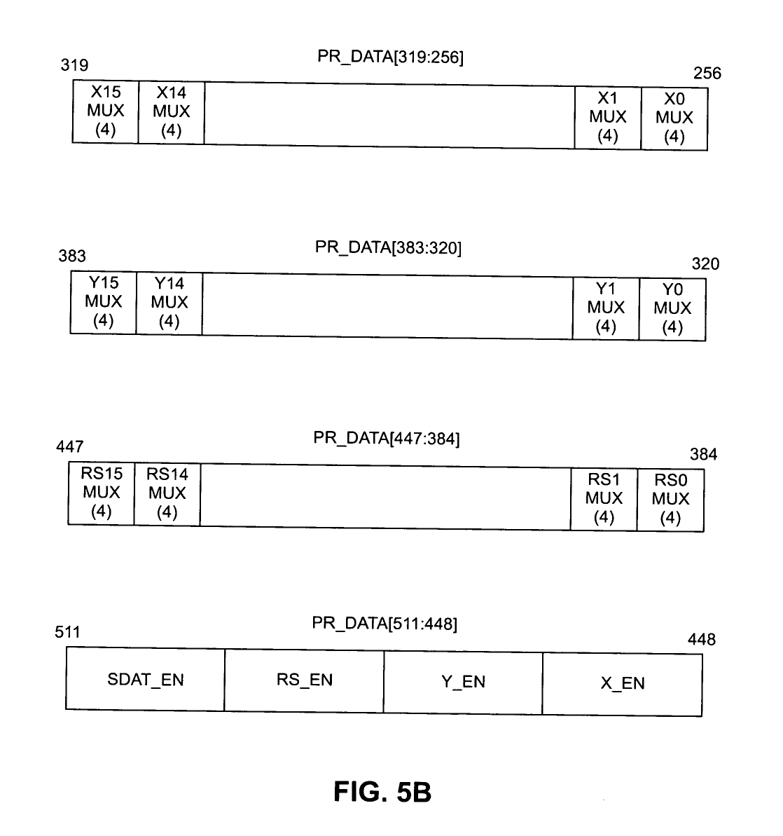

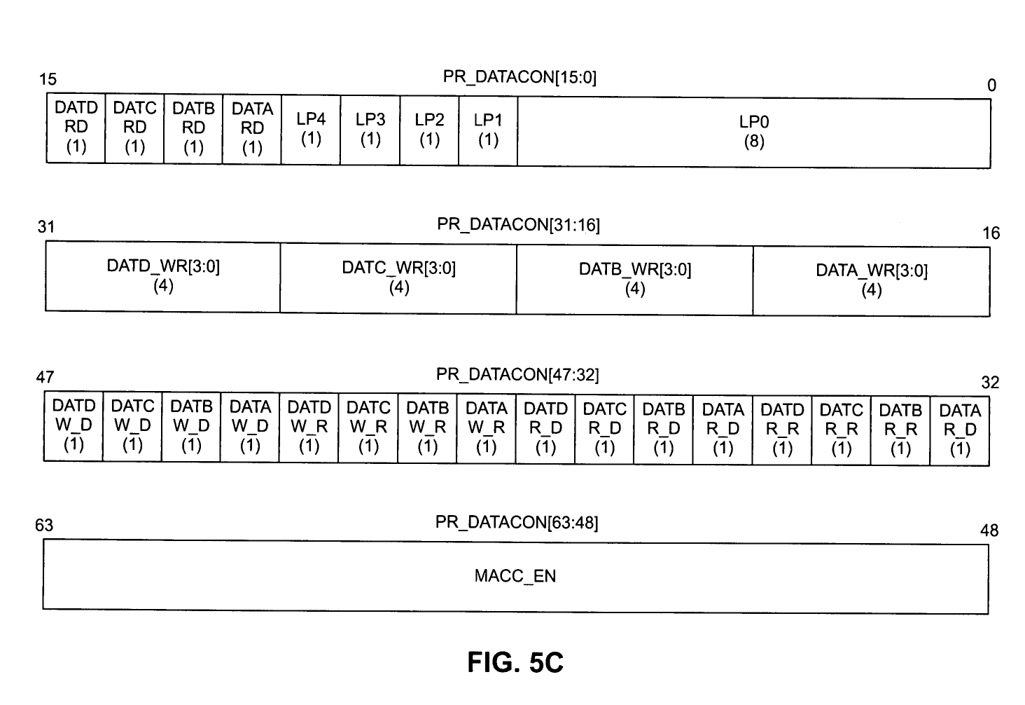

FIGS. 5A-5C illustrate a VLIW instruction set for a multiple MAC unit CRISP similar to CRISP 100d in FIG. 4 according to one embodiment of the present invention. The exemplary VLIW instruction set comprises up to 576 bits. These 576 bits are the superset of instructions available to a real application. However, less instruction bits (i.e., shorter VLIW instructions) may be used based on the application. For example, the subset of instructions for an FIR filter function may be different (i.e., larger or smaller) than the subset of instructions for an FFT function. Combinations of the two will support both applications. The derivation of a particular subset from the superset may be done using a development tool.

CRISP 100d comprises arrays of multiplexers (not shown) that couple the inputs and the outputs of the 16 MAC units to registers D0-D15, SD-SD15, and the data buses of CRISP 100d. Many of the data fields in the exemplary 576-bits VLIW instruction are used to control the multiplexers (MUXs) to couple any of the 16 MAC units to any of the registers D0-D15, any of the registers SD0-SD15, or any of the data buses. For example, in FIG. 5A, the first 64-bit word, PR_Data[63:0], comprises sixteen 4-bit fields, D0_MUX through D15_MUX. Each 4-bit field contains a MUX select signal that has 16 possible values. Likewise, the second 64-bit word, PR_Data[127:64], comprises sixteen 4-bit fields, SD0_MUX through SD15_MUX, and the third 64-bit word, PR_Data[191:128], comprises sixteen 4-bit fields: DA0_MUX-DA3_MUX, DB0_MUX-DB3_MUX, DC0_MUX-DC3_MUX, and DD0_MUX-DD3_MUX.

In FIG. 5A, the fourth 64-bit word, PR_Data[255:192], comprises four 16-bit fields. The D_EN and SD_EN fields each contain 16 register enable bits. The LIMIT_EN field contains 16 overflow bits, one for each of the 16 MAC units. The MNEG field contains 16 bits indicating a negative value, one for each MAC unit.

Additional MUX select signals and enable signals are shown in FIG. 5B. The fifth 64-bit word, PR_Data[319:256], comprises sixteen 4-bit fields, X0_MUX through X15_MUX. The sixth 64-bit word, PR_Data[383:320], comprises sixteen 4-bit fields, Y0_MUX through Y15_MUX. The seventh 64-bit word, PR_Data[447:384], comprises sixteen 4-bit fields, RS0_MUX through RS15_MUX. The eighth 64-bit word, PR_Data[511:448], comprises four 16-bit fields, X_EN, Y_EN, RS_EN, and SDAT_EN.

The final 64 bits of the 576-bit VLIW instructions are shown in FIG. 5C. A first 16-bit control word, PR_DataCon[15:0], comprises eight 1-bit fields, DATD_RD, DATC_RD, DATB_RD, DATA_RD, LP4, LP3, LP2, LP1 and an 8-bit field, LP0. The second 16-bit control word, PR_DataCon[31:16], comprises four 4-bit fields, DATD_WR[3:0], DATC_WR[3:0], DATB_WR[3:0], and DATA_WR[3:0]. The third 16-bit control word, PR_DataCon[47:31], comprises sixteen 1-bit fields. The first group of four bits comprises: DATDW_D, DATCW_D, DATBW_D, and DATAW_D. The second group of four bits comprises: DATDW_R, DATCW_R, DATBW_R, and DATAW_R. The third group of four bits comprises: DATDR_D, DATCR_D, DATBR_D, and DATAR_D. The final group of four bits comprises: DATDR_R, DATCR_R, DATBR_R, and DATAR_R.

The reconfigurable complex MAC unit architecture in CRISP 100d provides a low-cost, low-power application for MAC-based operations in both wireless infrastructure (e.g., base stations) and wireless mobile devices (e.g., cell phones). CRISP 100d improves performance and power efficiency over conventional reconfigurable MAC architectures and die area is significantly reduced, thereby allowing higher bit rate parallel processing.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A reconfigurable signal processor comprising:
a reconfigurable data path comprising a plurality of reconfigurable multiply-accumulate (MAC) units; and
a programmable finite state machine for controlling the plurality of reconfigurable MAC units, wherein the programmable finite state machine executes a first plurality of context-related instructions that cause selected ones of the plurality of reconfigurable MAC units to perform at least one of a defined set of functions consisting essentially of: i) Fourier transform functions; and ii) filter functions.

2. The reconfigurable signal processor as set forth in claim 1, wherein the Fourier transform functions comprise a Fast Fourier Transform (FFT) function and an Inverse Fast Fourier Transform (FFT) function.

3. The reconfigurable signal processor as set forth in claim 1, wherein the filter functions comprise at least a finite impulse response (FIR) filter function and an infinite impulse response (IIR) filter function.

4. The reconfigurable signal processor as set forth in claim 1, wherein the reconfigurable data path is configured by reconfiguration bits received from an external controller.

5. The reconfigurable signal processor as set forth in claim 4, wherein the programmable finite state machine is configured by reconfiguration bits received from the external controller.

6. The reconfigurable signal processor as set forth in claim 3, wherein a first one of the plurality of reconfigurable MAC units is disabled by the programmable finite state machine during a time period when the programmable finite state machine causes a second one of the plurality of reconfigurable MAC units to perform one of the Fourier transform function and the filter function.

7. The reconfigurable signal processor as set forth in claim 3, wherein the programmable finite state machine selectively enables the plurality of reconfigurable MAC units according to a data rate at which the reconfigurable signal processor is operating.

8. A mobile station capable of operating in a wireless network, the mobile station comprising:
a radio frequency (RF) transceiver that receives an incoming RF signal from the wireless network and generates therefrom a down-converted digital signal; and
a reconfigurable signal processor that processes sample of the down-converted digital signal, the reconfigurable signal processor comprising:
a reconfigurable data path comprising a plurality of reconfigurable multiply-accumulate (MAC) units; and
a programmable finite state machine for controlling the plurality of reconfigurable MAC units, wherein the programmable finite state machine executes a first plurality of context-related instructions that cause selected ones of the plurality of reconfigurable MAC units to perform at least one of a defined set of functions consisting essentially of:
i) Fourier transform functions; and ii) filter functions.

9. The mobile station as set forth in claim 8, wherein the Fourier transform functions comprise a Fast Fourier Transform (FFT) function and an Inverse Fast Fourier Transform (FFT) function.

10. The mobile station as set forth in claim 8, wherein the filter functions comprise at least a finite impulse response (FIR) filter function and an infinite impulse response (IIR) filter function.

11. The mobile station as set forth in claim 8, wherein the reconfigurable data path is configured by reconfiguration bits received from an external controller in the mobile station.

12. The mobile station as set forth in claim 11, wherein the programmable finite state machine is configured by reconfiguration bits received from the external controller.

13. The mobile station as set forth in claim 10, wherein a first one of the plurality of reconfigurable MAC units is disabled by the programmable finite state machine during a time period when the programmable finite state machine causes a second one of the plurality of reconfigurable MAC units to perform one of the Fourier transform function and the filter function.

14. The mobile station as set forth in claim 10, wherein the programmable finite state machine selectively enables the plurality of reconfigurable MAC units according to a data rate at which the wireless network is operating.

15. A software-defined radio (SDR) system that operates under a plurality of wireless communication standards, the SDR system comprising a reconfigurable signal processor comprising:
a reconfigurable data path comprising a plurality of reconfigurable multiply-accumulate (MAC) units; and
a programmable finite state machine for controlling the plurality of reconfigurable MAC units, wherein the programmable finite state machine executes a first plurality of context-related instructions that cause selected ones of the plurality of reconfigurable MAC units to perform at least one of a defined set of functions consisting essentially of: i) Fourier transform functions; and ii) filter functions.

16. The software-defined radio (SDR) system as set forth in claim 15, wherein the Fourier transform functions comprise a Fast Fourier Transform (FFT) function and an Inverse Fast Fourier Transform (FFT) function.

17. The software-defined radio (SDR) system as set forth in claim 15, wherein the filter functions comprise at least a finite impulse response (FIR) filter function and an infinite impulse response (IIR) filter function.

18. The software-defined radio (SDR) system as set forth in claim 15, wherein the reconfigurable data path is configured by reconfiguration bits received from an external controller in the SDR system.

19. The software-defined radio (SDR) system as set forth in claim 18, wherein the programmable finite state machine is configured by reconfiguration bits received from the external controller.

20. The software-defined radio (SDR) system as set forth in claim 17, wherein a first one of the plurality of reconfigurable MAC units is disabled by the programmable finite state machine during a time period when the programmable finite state machine causes a second one of the plurality of reconfigurable MAC units to perform one of the Fourier transform function and the filter function.

21. The software-defined radio (SDR) system as set forth in claim 17, wherein the programmable finite state machine selectively enables the plurality of reconfigurable MAC units according to a data rate at which the SDR system is operating.
